(19) United States
(12) Patent Application Publication
(10) Pub. No.: US 2005/0229795 A1
(43) Pub. Date: Oct. 20, 2005

(54) Battery operated portable juicer and blender

(76) Inventor: Priscilla Stuckey, New York, NY (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/110,275

(22) Filed: Apr. 20, 2005

Related U.S. Application Data
(60) Provisional application No. 60/563,510, filed on Apr. 20, 2004.

(51) Int. Cl. A23N 1/00

(52) U.S. Cl. 99/510

(57) ABSTRACT

The present invention provides a portable, compact, and light-weight juicer and blender capable of being operated by batteries. For portability, juice is collected in a container placed inside the juicer and blender. For convenience and ease of use, food residue or pulp is expelled through a spout into a bag attached to the spout. The food processor described herein is versatile, portable and easy to use making it an appliance that can be used anywhere.

### CROSS-REFERENCE TO RELATED APPLICATIONS

The present invention claims the benefit of U.S. Provisional Patent Application Ser. No. 60/563,510, filed Apr. 20, 2004, entitled “To go Juicer,” the contents of which are hereby incorporated by reference as if set forth fully herein.

### FIELD OF THE INVENTION

The present invention is directed towards a portable appliance, and more particularly, to a compact and light-weight portable juicer and blender capable of being operated by batteries.

### BACKGROUND OF THE INVENTION

Presently, various devices can be used to extract juice from comestibles such as fruit and vegetable. The food juicers are of two major types: (i) the food-crushing type; and (ii) the emulsifying type.

In the food-crushing type, juice is extracted by squeezing food between metal gears driven by a powerful motor rotating at a low speed. This type of food processor is capable of juicing wheat grass and nuts, as well as creating various pastes and jams.

In the emulsifying type of juicing, grating of comestibles or food is accomplished by pushing the food into contact with a horizontal grating disk rotating at high speed. This grating process extracts juice and pulp from fruits and vegetables. The grating disk is generally surrounded by a meshed filter. The centrifugal force of the rotating grating disk and filter pushes the juice through the filter to a collection bowl, and pushes the pulp along the sides of the filter to be collected in the juicer or ejected out of the juicer.

While typical juicers may efficiently extract juice from fruits and vegetables, dried pulp clogs the filter requiring the user to manually empty the juicer of the pulp on a regular basis. The prior art addressed this problem in various ways.

U.S. Pat. No. 5,421,248,to Hsu, discloses a food residue removal feature in which a stopper element is positioned in the open interior space of the filter assembly. As the filter assembly spins, the stopper is engaged at a certain position. The food residue collects against the stopper and is forced upwardly against the interior wall of the filter assembly into numerous compartments. The filter housing is bowl-shaped and has vertical side walls. The drawbacks of the Hsu structure is that dried dregs or food residue clog in the top cover assembly. The user must then remove the assembly for manual extraction of the dregs. Other problems include increased building costs, increased complexity in the top cover of the juicer, and increased likelihood of component failure.

U.S. Pat. No. 4,506,601, to Ramirez et al., discloses a fruit and vegetable juicer. The juicer has pulp discharge control means comprising a cylindrical rim or circular band having flexible vanes attached to the rim such that the vanes flex and extend radially outward due to centrifugal forces when the spindle rotates. Discharge means are disposed in the filter basket. As the filter basket spins, the vanes push outwardly and press the pulp against the filter basket. The pulp is forced up and discharged through an outlet duct. This configuration exhibits some of the same short-comings as described above. Dried pulp lodges in the outlet duct or under the top cover. The increased mechanical complexity of the pulp discharge element is costly to build and more susceptible to mechanical breakdown.

U.S. Pat. No. 4,700,621, to Elger, and U.S. Pat. No. 5,479,851, to McClean et al., both disclose a fruit and vegetable juicer having a frustoconical filter basket and passageways which serve to direct pulp to a collection area. However, the pulp lodges in the top cover at various locations. In Elger, the pulp creeps up the surface of the filter basket and must be caught in a “pulp trough.” The top cover assembly still must periodically be removed to clean out the passageways and underside of the top cover to further use the juicer. In McClean, the top cover 15 can easily clog as pulp is extracted from the filter basket. The McClean cover provides little space and no efficient guiding surfaces to control the pulp extraction path.

U.S. Pat. No. 5,495,795, to Harrison et al., disclosing a curved chute in order to facilitate the ejection of the pulp and prevent the clogging of the filter. In Harrison, however, the chute is large and bulky, and the residue is collected in a large pulp. This feature prevents the apparatus from being compact and portable.

Furthermore, in all of the above-mentioned examples, the receptacle for collecting the juice is placed outside of the juicer. This is another feature that prevents the prior art from being compact and portable.

### SUMMARY OF THE INVENTION

All of the juicers of the prior art require the juicer to be supplied with alternate current (AC) from a standard electrical outlet. Furthermore, none of the juicers available in the prior art uses a disposable bag or any type of bag receptacle to collect the ejected pulp or food residue. Also, none of the juicers in the prior art benefit from a self-contained design wherein the juice-collecting container can be placed inside the housing of the juicer for ease of transportation and use.

The above-mentioned shortcomings of the juicers of the prior art are solved by the portable juice extractor disclosed and claimed herein.

What is needed in the art is a juicer that is compact, light weight, and capable of being operated by batteries. These features allow the juicer to be used anywhere, and at anytime, without the restriction of being in close proximity to an AC electrical outlet. For example, the juicer may be used on the beach or in the wilderness where an AC electrical outlet is not available. Furthermore, in one embodiment, the portable juicer may be converted to a portable blender equipped with rotating blades for mixing various juices.

The present invention addresses these needs by combining ease of use with portability and power efficiency. Allowing the collection of juice in a cup that is placed inside the juicer creates an integrated design that makes the juicer portable and easy to use. Ease of use is also accomplished by collecting the pulp using a bag that is attached to a pulp-ejection spout by an easily releasable ring.

### BRIEF DESCRIPTION OF THE DRAWINGS

FIG. 1 is a general view of the an embodiment of a juicer in accordance with the present invention.

FIG. 2 is a perspective view of an embodiment of a juicer in accordance with the present invention.

FIG. 3 is a top view of a filter basket with the grating disc inserted within.

FIG. 4 is a sectional view of FIG. 3 along the line A-A.

### DETAILED DESCRIPTION OF THE INVENTION

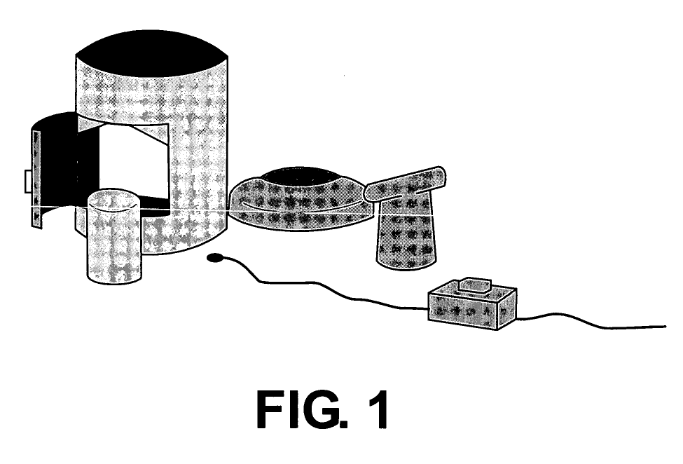

A first embodiment of the present invention is shown in FIG. 1. FIG. 1 is a general overview of a portable juicer with a base equipped with an opening to insert a receptacle. FIG. 1 also shows a charger for recharging a battery, the charger can either recharge the battery while it is in the juicer or the battery can be affixed to the charger for charging. The charger can also supply power for the operation of the juicer while charging the battery. The battery may be, but is not limited to, dry cells, nickel-metal hydride, lithium ion, nickel cadmium, sealed lead acid batteries, and the like. As shown, the juicer can be easily disassembled for cleaning. Also shown, is a pusher for pushing comestibles into contact with a grinding surface.

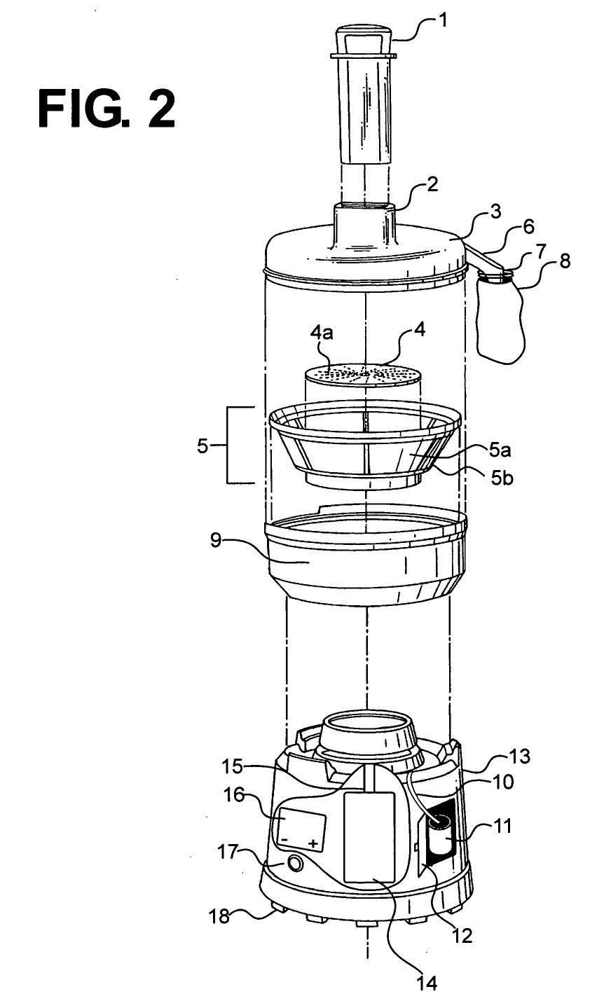

Another embodiment of the present invention is shown in FIG. 2. FIG. 2 is a perspective view of a portable juicer capable of being operated on batteries. The apparatus includes a food pusher 1, a feeding tube 2, a top cover 3, a grating disk 4, a filter 5, a filter mesh 5a equipped with pulp-guiding grooves 5b, a pulp ejection spout 6, a clamp 7 for securing a pulp-collecting bag 8 to the pulp ejection spout 6, a juice collection bowl 9, at least one juice collecting duct 10, a juice collecting cup 11, an opening 12 in juicer casing 13 to allow the insertion of the juice collecting cup 11 inside the juicer casing 13. The apparatus also includes a motor 14 engaged with a driving means 15 for rotating the filter 5 and grating disk 4.

The driving means 15 may include, but is not limited to, driving gear of various ratios, drive shafts, pulleys, belts, worm gears or the like. In one embodiment, the driving means 15 has a drive ratio so that the grating disk and filter rotate at a rate that is faster then the rotating rate of the motor 14. This embodiment offers less torque but higher rotational speed. In another embodiment, the driving means 15 has a drive ratio so that the grating disk and filter rotate at a rate that is lower then the rotating rate of the motor 14. This embodiment offers more torque but a lower rotational speed.

In another embodiment, the motor has at least two speeds. In yet another embodiment, the motor is equipped with a variable speed controller.

The motor is supplied with power using a battery 16 that is also connected to a recharging outlet 17. The apparatus is preferably equipped with at least one suction cup 18 placed on the bottom of the juicer casing 13 for stability and ease of use.

This apparatus can be easily disassembled and reassembled for cleaning purposes. The top cover 3, grating disk 4, filter 5, juice collection bowl 9 and juicer casing 13 may all be disengageable for cleaning purposes.

In an alternate embodiment, the above-described portable motorized apparatus for juicing food may be converted to a portable motorized blender. In this embodiment, the grating disk 4, juice collection bowl 9 and filter 5 are disassembled from the juicer casing and replaced with a juice mixing container equipped with rotating blades (not shown) for mixing various juices. The bottom of the juice mixing container is designed to be engaged with the motor 14 and juicer casing, while the top of the juice mixing container is designed to be engaged with the top cover 3.

In either of the above-mentioned embodiments, the battery 16 is recharged using a standard charger, a solar-powered charger or a mechanical charger. A solar-powered charger harnesses the power of solar rays and converts them to electrical current to charge the battery, while a mechanical charger generates electrical current as a result of a user cranking a shaft of a dynamo.

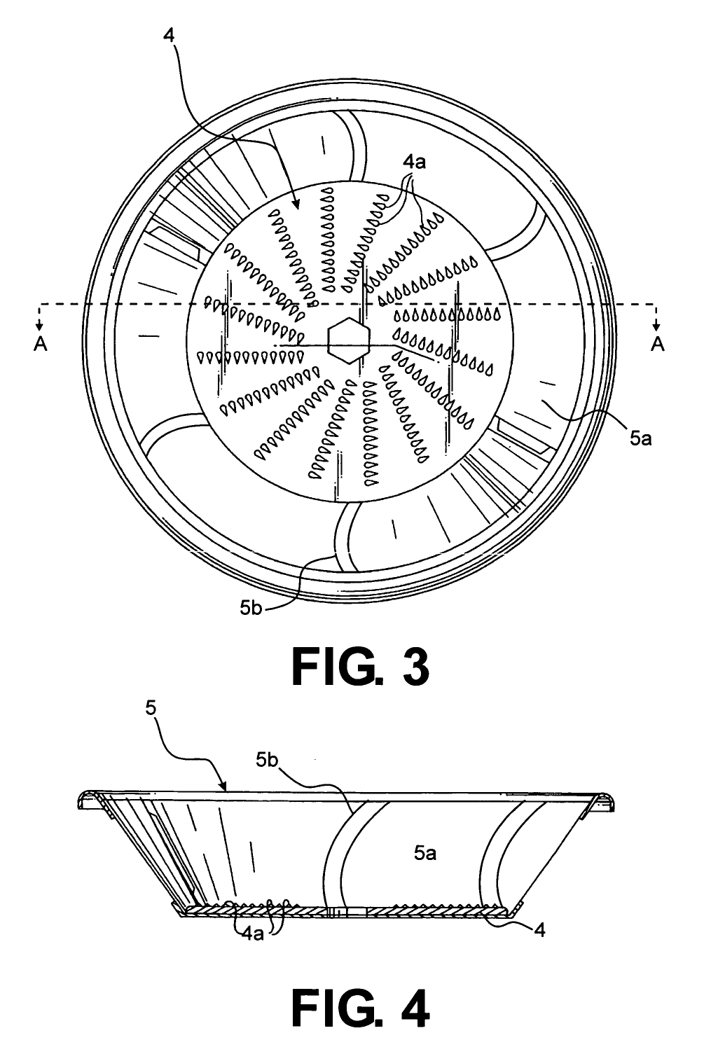

FIG. 3 is a top view of the filter basket with the grating disc inserted within. When comestibles are pushed through the feeding tube 2 using the pusher 1, comestibles contact grating teeth 4a of the grating disk 4 that is rotating at high speed. The grating creates juice and pulp. The rotation of the grating disk 4 and filter 5 creates a centrifugal force that pushes the juice through the meshed sidewall 5a of the filter 5. The pulp does not go through the meshed sidewall 5a of the filter 5. Instead, the centrifugal force caused by the rotation of the grating disk 4 and filter 5 causes the pulp to travel along the meshed sidewall 5a and reach the top cover 3 to be eventually expelled through the pulp ejection spout 6 and collected in the pulp-collecting bag 8. The pulp-collecting bag 8 is held to the pulp-ejection spout 6 using clamp 7. In one embodiment, the pulp-collecting bag 8 is perforated is to allow the escape of air yet retains the pulp inside the bag.

In one embodiment, the grating disk 4 and filter 5 are a single element. The single component is not conical as shown in FIGS. 3 and 4, instead it is substantially planar. In this manner, the comestibles are pulverized and the juice passes through the filter. The detritus is then forced towards the outer edge of the grating disk and filter assembly and then discharged through the pulp ejection spout 6.

In another embodiment, the juice filter 5 is equipped with pulp-guiding grooves 5b in order to accelerate or facilitate the movement of the pulp to the top of the filter. The filter is made of a micro-mesh that allows liquid to go through but blocks particular matter. The micro-mesh In one embodiment, the grating disk 4 and filter 5 form a one unit assembly. The micro-mesh is made of metal, plastic or fabric. In another embodiment, the mesh can be replaced so that some of the particulate matter or pulp is passed through the filter and collected in the juice collecting cup 11.

FIG. 4 is a sectional view of FIG. 3 along the line A-A. The pulp-guiding grooves 5b are curved in order to be an effective guide to the pulp that is traveling through and parallel to the pulp-guiding grooves 5b due to the centrifugal force of the rotating filter 5.

Although the present invention was discussed in terms of certain preferred embodiments, the description is not limited to such embodiments. Rather, the invention includes other embodiments including those apparent to a person of ordinary skill in the art.

1. A portable juicer comprising:
a base, the base comprising:
an outer casing having an opening for inserting a cup inside the base,
a rechargeable battery, and
a motor attached to a driving mechanism;
a grating disk engaged to the driving mechanism;
a filter engaged to the driving mechanism; and
a top cover engaged to the base, the juicer top cover comprising:
a feeding tube, and
a discharge chute having a clamp for removably attaching a bag to the discharge chute.

2. The portable food juicer according to claim 1, wherein the grating disk and the filter are one integrated unit.

3. The portable food juicer according to claim 1, wherein a bottom of the base is equipped with at least one suction cup.

4. The portable food juicer according to claim 1, wherein the juicer casing is equipped with a recharging port.

5. The portable food juicer according to claim 1, wherein the bottom and side walls of the filter are made of micro-mesh.

6. The portable food juicer according to claim 1, wherein the bottom and side walls of the filter are equipped with scores.

7. The portable food juicer according to claim 1, wherein the bag is perforated.

8. The portable food juicer according to claim 7, wherein the bag is biodegradable.

9. A portable juicer comprising:
grating means for grating comestibles;
filtering means for filtering juice;
a top cover engaged to a base, the top cover comprising:
a feeding tube,
discharge means for discharging pulp out of the portable juicer,
collection means for collecting discharged pulp, and
attachment means for attaching the collection means to the discharge means; and
a base, the base having:
an outer casing equipped with an opening for inserting a cup inside the base,
a rechargeable battery for powering the driving means, and
driving means for rotating the grating means.

10. A portable juicer according to claim 9, wherein the driving means is used for rotating the grating means and the filtering means.

11. A portable juicer according to claim 9, wherein the driving means is engaged with a gearing unit comprised of mechanical devises selected from a group consisting of gears, pulleys, worm shafts and belts.

12. A portable juicer according to claim 9, wherein the filtering means is formed of material selected from a group consisting of metal, plastic, micro-mesh, and fabric.

13. A portable juicer according to claim 9, wherein the attachment means engaged with the discharge means is selected from a group consisting of clamps, fasteners, connectors and couplers.

14. A method of juicing using a portable juicer, comprising:
charging a battery of the juicer by connecting the juicer to a power source;
disconnecting the juicer from the power source;
inserting comestibles into the juicer and pressing the food against a grating disk; and
collecting the juice in a receptacle.

15. The method for juicing using a portable juicer according to claim 14, wherein the receptacle is placed inside the juicer.

16. The method for juicing using a portable juicer according to claim 14, further comprising:
attaching a bag to a spout using attachment means;
expelling pulp through the spout; and
detaching the bag from the spout after juicing is complete.

17. The method for juicing using a portable juicer according to claim 14, wherein the battery is charged using solar power.
